(19) United States
(12) Patent Application Publication
(10) Pub. No.: US 2026/0203559 A1
(43) Pub. Date: Jul. 16, 2026

(54) AUTOMATIC RICHER PRESENTATION OF QUANTITATIVE DATA WITH GENERATIVE AI SYSTEMS

(71) Applicant: Babu Vinod, palo alto, CA (US)

(72) Inventor: Babu Vinod, palo alto, CA (US)

(21) Appl. No.: 19/096,636

(22) Filed: Mar. 31, 2025

Related U.S. Application Data
(63) Continuation-in-part of application No. 18/919,420, filed on Oct. 17, 2024, now abandoned.
(60) Provisional application No. 63/544,633, filed on Oct. 17, 2023.

(51) Int. Cl. G06N 3/0475; G06F 40/40; G06T 11/26

(52) U.S. Cl. CPC G06N 3/0475; G06T 11/26; G06F 40/40

(57) ABSTRACT

A computerized method for used for automatic richer presentation of quantitative data with generative artificial intelligence (AI), comprising: obtaining a set of quantitative data to provide a richer presentation; determining a set of statistical attributes of the set of quantitative data; and inputting portions of the quantitative data set as one or more prompts into at least one text-to-image Generative AI model to generate one or more richer presentations of the quantitative data.

### CLAIM OF PRIORITY

This patent application claims priority to U.S. Provisional Patent Application No. 63/544,633, filed on Oct. 17, 2023. This Provisional Patent Application is hereby incorporated by reference in its entirety.

### BACKGROUND

In today's data-driven world, organizations are inundated with vast amounts of quantitative information, often struggling to extract meaningful insights and communicate them effectively. Traditional data visualization methods, while useful, often fall short in engaging diverse audiences and conveying complex patterns in an easily digestible manner. The increasing complexity and volume of data require more sophisticated approaches to data presentation that can adapt to different contexts and audience needs. Generative AI offers a powerful solution to these challenges by enabling the creation of dynamic, personalized, and context-aware data presentations.

By leveraging generative AI, organizations can transform raw numbers into compelling narratives and visuals that resonate with various stakeholders, from executives to the general public. This technology allows for the automatic generation of infographics, interactive visualizations, and even immersive augmented reality experiences, making data more accessible and actionable. Moreover, the ability of generative AI to simulate expert knowledge and generate hypothetical scenarios enhances decision-making processes, enabling organizations to explore potential outcomes and strategies based on their data. As data literacy becomes increasingly crucial in both professional and public spheres, generative AI-powered data presentation systems represent a significant leap forward in democratizing data understanding and fostering data-driven cultures across industries.

### SUMMARY OF THE INVENTION

In one aspect, a computerized method for used for automatic richer presentation of quantitative data with generative artificial intelligence (AI), comprising: obtaining a set of quantitative data to provide a richer presentation; determining a set of statistical attributes of the set of quantitative data; and inputting portions of the quantitative data set as one or more prompts into at least one text-to-image Generative AI model to generate one or more richer presentations of the quantitative data.

### BRIEF DESCRIPTION OF THE DRAWINGS

FIG. 1 illustrates an example process used for automatic richer presentation of quantitative data with generative AI systems, according to some embodiments.

FIG. 2 illustrates an example automatic richer presentation of quantitative data with generative AI system, according to some embodiments.

FIG. 3 illustrates an example generative AI system for the presentation of quantitative data, according to some embodiments.

FIG. 4 illustrates an example process for implementing a Generative AI Integration in Quantitative Data Presentation module, according to some embodiments.

The Figures described above are a representative set and are not an exhaustive with respect to embodying the invention.

### DESCRIPTION

Disclosed are a system, method, and article of manufacture for automatic richer presentation of quantitative data with generative AI systems. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Artificial intelligence art is any visual artwork created through the use of artificial intelligence (AI) programs.

Application program is a computer program designed to carry out a specific task other than one relating to the operation of the computer itself, typically to be used by end-users.

Generative AI refers to artificial intelligence systems that can create new content, such as images, text, audio, or data, based on patterns learned from existing data. These systems typically use deep learning architectures, particularly generative models like Generative Adversarial Networks (GANs), Variational Autoencoders (VAEs), or large language models based on transformer architectures. A core principle involves training the AI on vast datasets to learn the underlying statistical distributions and patterns, enabling it to generate new, original content that mimics the characteristics of the training data. Generative AI models often employ techniques such as unsupervised or self-supervised learning, allowing them to discover complex features and relationships within the data without explicit labeling. The output of generative AI can range from highly realistic synthetic data to creative and novel content, making it applicable in fields such as art creation, data augmentation, simulation, and content generation.

Generative Pre-trained Transformer 4 (GPT-4) is a multimodal large language model created by OpenAI, and the fourth in its numbered “GPT-n” series of GPT foundation models. As a transformer-based model, GPT-4 was pretrained to predict the next token (e.g. using both public data and data licensed from third-party providers) and was then fine-tuned with reinforcement learning from human and AI feedback for human alignment and policy compliance. It is noted that other multimodal large language model can be utilized in other example embodiments.

Deep learning is part of a broader family of machine learning methods based on artificial neural networks with representation learning. Learning can be supervised, semi-supervised or unsupervised.

Deep neural network (DNN) is an artificial neural network (ANN) with multiple layers between the input and output layers. There are different types of neural networks, but they always consist of the same components: neurons, synapses, weights, biases, and functions.

Large language model (LLM) is a language model characterized by emergent properties enabled by its large size. An LLM can be built with artificial neural networks. These can be pre-trained. The training can utilize self-supervised learning and/or semi-supervised learning. For example, the artificial neural networks can contain tens of millions to billions of weights. The LLMs can be trained using a specialized AI accelerator hardware to parallel process vast amounts of text data, mostly scraped from the Internet. As language models, they work by taking an input text and repeatedly predicting the next token or word.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, logistic regression, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees'habit of overfitting to their training set. Deep learning is a family of machine learning methods based on learning data representations. Learning can be supervised, semi-supervised or unsupervised.

Natural language processing (NLP) is a branch of artificial intelligence concerned with automated interpretation and generation of human language. Natural language processing (NLP) is an interdisciplinary subfield of linguistics, computer science, and artificial intelligence concerned with the interactions between computers and human language, in particular how to program computers to process and analyze large amounts of natural language data. The goal is a computer capable of “understanding” the contents of documents, including the contextual nuances of the language within them. The technology can then accurately extract information and insights contained in the documents as well as categorize and organize the documents themselves. Challenges in natural language processing frequently involve speech recognition, natural-language understanding, and natural-language generation.

Optical character recognition or optical character reader (OCR) is the electronic or mechanical conversion of images of typed, handwritten, or printed text into machine-encoded text, whether from a scanned document, a photo of a document, a scene-photo and/or from subtitle text superimposed on an image.

Text-to-image model is a machine learning model which takes an input natural language description and produces an image matching that description. Example models include, inter alia, OpenAI's DALL-E 2®, Google® Brain's Imagen, StabilityAI's Stable Diffusion®, Midjourney®, etc. Text-to-image models can combine a language model, which transforms the input text into a latent representation, and a generative image model, which produces an image conditioned on that representation.

These systems and functions can be incorporated into various embodiments discussed herein.

### Example Systems and Methods

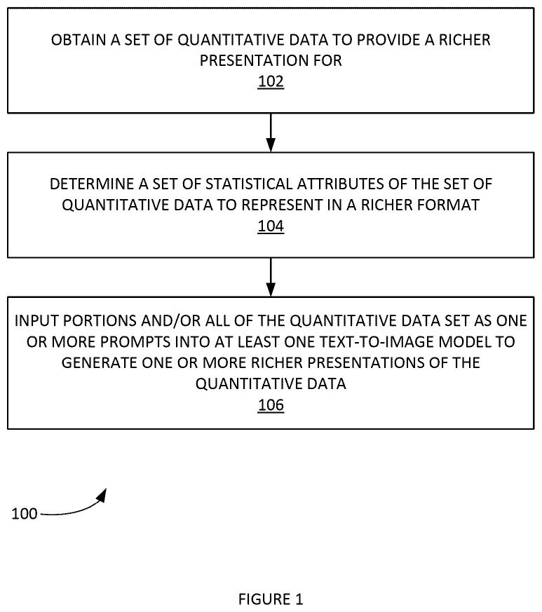

FIG. 1 illustrates an example process 100 used for automatic richer presentation of quantitative data with generative AI systems, according to some embodiments.

Process 100 can use the quantitative data sets as prompts into one or more text-to-image models. Process 100 can develop these one or more text-to-image models using various deep learning methodologies to generate digital images from, inter alia: natural language descriptions, quantitative data sets, meeting notes, white board notes/drawings, etc. This information can be organized into prompts for the one or more text-to-image models.

More specifically, in step 102, process 100 obtains a set of quantitative data to provide a richer presentation for. Thee data sets can include, inter alia: demographic cohort data, education institution data, health institution data, government data sets, sports data, actuarial data, real-estate data sets, economic data sets, biological data sets, geographical data sets, etc.

In step 104, process 100 determines a set of statistical attributes of the set of quantitative data to represent. Example statistical measures that can be calculated and visualized via the text-to-image model include, inter alia: proportion/percentage, of data values in each category, mean, median, mode, percentiles, range, variance, standard deviation, various outliers, other numerical measures for quantitative data, etc.

In step 106, process 100 input portions and/or all of the quantitative data set as one or more prompts into at least one text-to-image model to generate one or more richer presentations of the quantitative data. Text-to-image models can be proprietary pre-trained and/or commercially available text-to-image models. It is further noted that the digital images can be converted to augmented reality images and the like. Additionally, the digital images and/or quantitative data sets can be used as prompts to generative AI art generation (e.g. using generative AI system(s) 204 and generative AI art generators 206, etc.). In this way, various type of richer presentations of the quantitative data can be provided.

It is noted that expert and/or other manual input can be used to supplement the prompts of process 100. The expert and/or other manual input can be used to modify the outputs of process 100 as well. An expert can also use various recommendation, LLM and ML systems (e.g. of system 200 infra) as well for the augmentations.

Moreover, in some examples, process 100 can enable an automated AI-based expert to leverage LLMs and/or other expert systems to provide automated explanations of the richer presentations of the quantitative data. This can be when an appropriate human expert is not available. This can be used to augment expert advice. Moreover, in some examples, a plurality of experts can be consulted to verify the richer presentations of the quantitative data. The plurality of experts can include both human and AI-based experts.

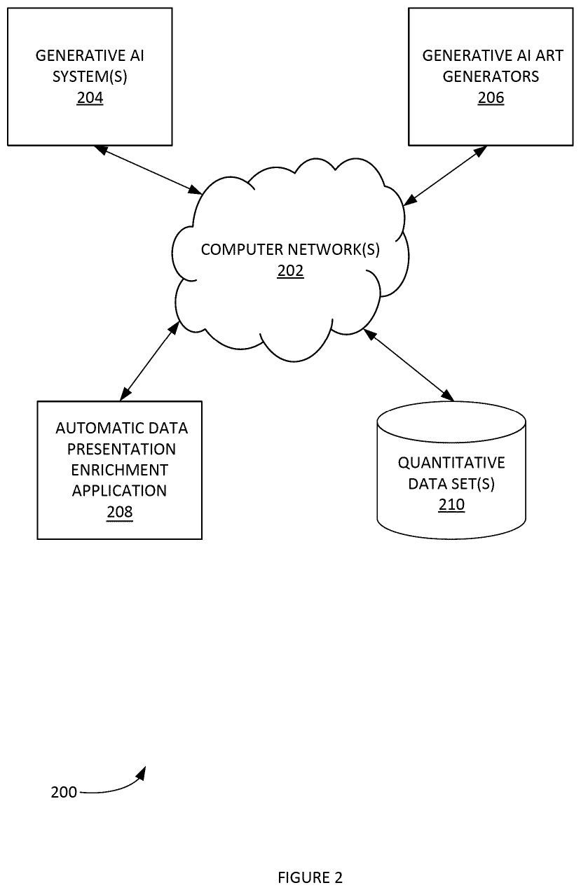

FIG. 2 illustrates an example automatic richer presentation of quantitative data with generative AI system 200, according to some embodiments. System 200 can perform process 100. System 200 can include automatic data presentation enrichment application 208. automatic data presentation enrichment application 208 obtain data sets of quantitative data from quantitative data sets 208. It is noted that quantitative data sets 208 can also include other types of data (e.g. qualitative data, metadata, etc.).

Automatic data presentation enrichment application 208 can include various functionalities. These can include, inter alia, an AI driven recommendation system, NLP systems, calculators, APIs, email servers, ML modules, computer vision modules, etc.

A Machine learning (ML) module can implement various optimizations and model related to training the various text-to-image models, AI art drawing models, etc. used herein. ML a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees'habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

Machine learning module 212 can also leverage one or more LLMs. Machine learning module 212 can provide explicit and implicit technician and/or AR head view generated queries to an LLM and receive content. This content can be used to populate AR elements, technician workflows, order queries to automatically obtain vehicle parts and/or services, etc.

There are several methods which may be used by automatic data presentation enrichment application 208 to select a proper sample size and/or use a given sample to make statements (within a range of accuracy determined by the sample size) about a specified population. These methods may include, for example:
1. Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived.
2. Bayesian Analysis as, for example, in “Bayesian Data Analysis” by A Gelman, I. B. Carlin, H. S. Stern and D. B. Rubin, Chapman and Hall 1995; Chapter 7, where several sampling designs are discussed.
3. Artificial Intelligence techniques, or other such techniques as Expert Systems or Neural Networks as, for example, in “Expert Systems: Principles and Programming” by Giarratano and G. Riley, PWS Publishing 1994; Chapter 4, or “Practical Neural Networks Recipes in C++” by T. Masters, Academic Press 1993; Chapters 15, 16, 19 and 20, where population models are developed from acquired data samples.

It is noted that these statistical methodologies are for exemplary purposes and other statistical methodologies can be utilized and/or combined in various embodiments. These statistical methodologies can be utilized elsewhere (e.g. in process 100), in whole or in part, when appropriate as well.

Example statistical measures that can be calculated and visualized via the text-to-image model include, inter alia: proportion/percentage, of data values in each category, mean, median, mode, percentiles, range, variance, standard deviation, various outliers, other numerical measures for quantitative data, etc.

System 200 can use the quantitative data sets as prompts into one or more text-to-image models. System 200 can develop these one or more text-to-image models using various deep learning methodologies to generate digital images from, inter alia: natural language descriptions, quantitative data sets, meeting notes, white board notes/drawings, etc. This information can be organized into prompts for the one or more text-to-image models.

System 200 can include networks 200, such as, the Internet, LANs, various enterprise networks, etc.

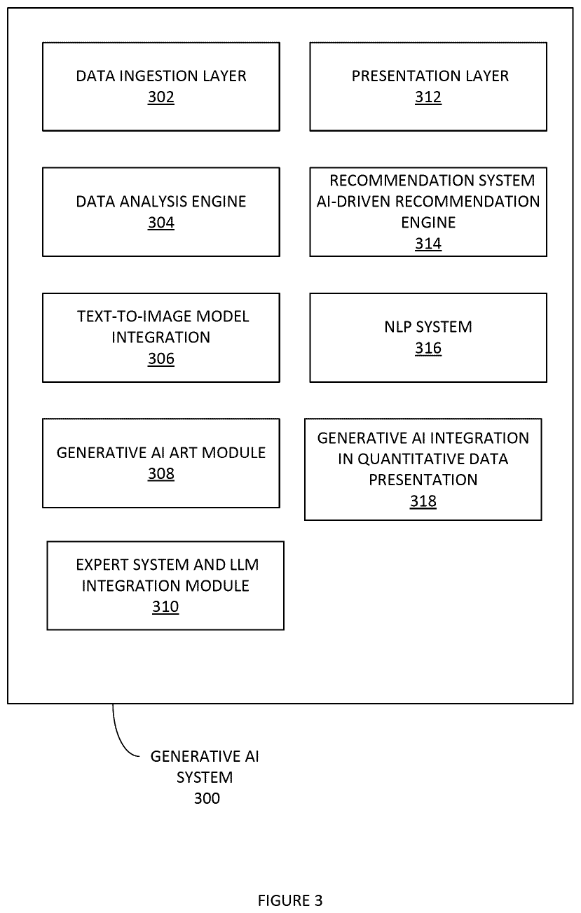

FIG. 3 illustrates an example generative AI system 300 for the presentation of quantitative data, according to some embodiments. Generative AI system 300 includes Data Ingestion Layer 302. Data Ingestion Layer 302 provides input interfaces for various data sources (e.g. demographic, educational, health, government, sports, etc.). Data Ingestion Layer 302 performs data parsing and standardization modules.

Generative AI system 300 includes Data Analysis Engine 304. Data Analysis Engine 304 performs statistical analysis. Data Analysis Engine 304 calculates measures like mean, median, mode, percentiles, range, variance, standard deviation, outliers Machine Learning module Implements various ML techniques (e.g. decision trees, neural networks, random forests, etc.). Data Analysis Engine 304 handles model training, validation, and testing.

Generative AI system 300 includes Text-to-Image Model Integration 306. API integrations with pre-trained text-to-image models Custom text-to-image model training pipeline Prompt generation module to convert quantitative data and statistical measures into suitable prompts.

Generative AI system 300 includes Generative AI Art module 308. Generative AI Art module 308 can perform generation and integration with generative AI art generators. Generative AI Art module 308 can include a conversion module for digital images to augmented reality (AR) format.

Generative AI system 300 includes an Expert System and LLM Integration module 310. Expert System and LLM Integration module provides various API connections to Large Language Models (LLMs). More specifically, the expert system provides for automated explanations of data presentations Interface for human expert input and augmentation.

Generative AI system 300 includes a Presentation Layer 312. Presentation Layer 312 provides visualization generation module with an interactive dashboard for displaying generated images and statistics AR/VR integration for immersive data presentation.

Generative AI system 300 includes a Recommendation System AI-driven recommendation engine 314 for suggesting relevant visualizations and insights.

Generative AI system 300 can includes an Natural Language Processing (NLP) System 316 For processing textual data and generating natural language descriptions of insights

Generative AI system 300 includes an API Layer. These can include, inter alia, RESTful APIs for system integration and external access to functionalities. Generative AI system 300 includes a Storage and Database Data system to manage a warehouse for storing raw and processed quantitative data Model storage for trained ML and text-to-image models. Generative AI system 300 can perform Security and Access Control. This can include authentication and authorization mechanisms such as data encryption and privacy controls.

Generative AI system 300 can perform Scalability and Performance operations. These can include, inter alia, load balancing for handling multiple requests. Generative AI system 300 perform various distributed computing capabilities for processing large datasets. Generative AI system 300 can perform Monitoring and Logging.

Here, Generative AI system 300 includes can performs system health monitoring Usage analytics and logging for continuous improvement This architecture provides a comprehensive framework for implementing the automatic richer presentation of quantitative data as described in the document. It combines various AI and ML techniques with data analysis and visualization capabilities to create an advanced system for data presentation and insights generation.

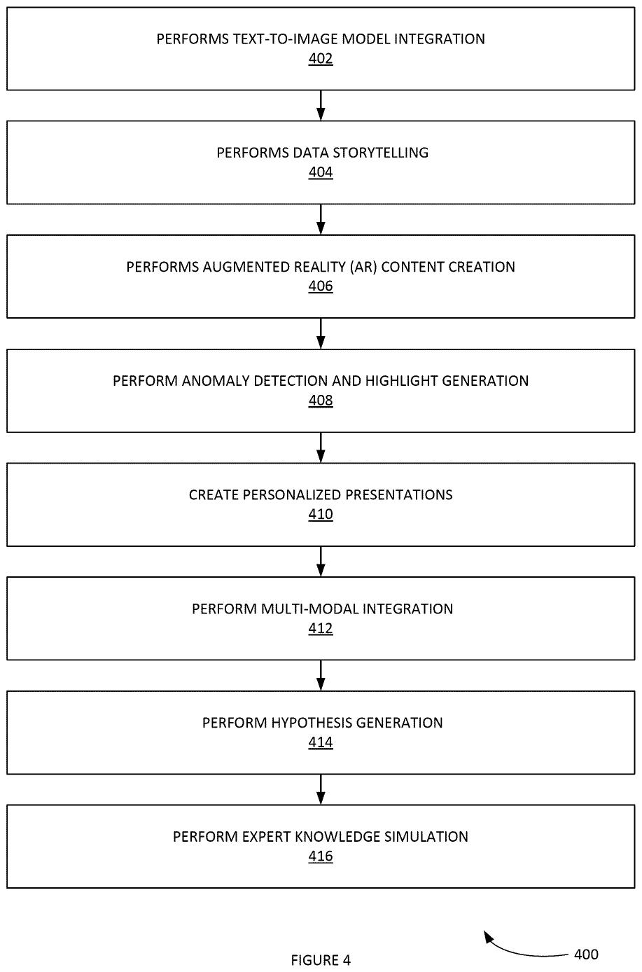

Generative AI Integration in Quantitative Data Presentation module 318 is now discussed. Generative AI plays a crucial role in transforming raw quantitative data into rich, visual presentations. Generative AI is leveraged in various steps as provided by FIG. 4.

FIG. 4 illustrates an example process 400 for implementing a Generative AI Integration in Quantitative Data Presentation module 318, according to some embodiments.

In step 402, process 400 performs Text-to-Image Model Integration. This can include a Prompt Generation. Generative AI can create sophisticated prompts from statistical analyses and data insights. For example, it could generate a prompt like “Create a vibrant infographic showing a 25% increase in renewable energy adoption, with wind turbines and solar panels against a cityscape background.” Process 400 performs Image Generation. Pre-trained text-to-image models (e.g., DALL-E, Stable Diffusion) can convert these prompts into visual representations of the data. This can result in custom infographics, charts, or artistic interpretations of the data. Process 400 performs Style Transfer. Generative AI can apply various artistic styles to the generated images, allowing for customized visual themes that align with brand guidelines or presentation contexts.

In step 404, process 400 performs Data Storytelling. Process 400 performs Narrative Generation. Large Language Models (LLMs) can be used to generate natural language descriptions and narratives that explain the data insights. This creates a story around the numbers, making the presentation more engaging and understandable. Process 400 provides Interactive Explanations. Generative AI can power chatbot-like interfaces that allow users to ask questions about the data and receive AI-generated explanations in real-time.

In step 406, process 400 performs Augmented Reality (AR) Content Creation. This can include 3D Model Generation. Generative AI can transform 2D visualizations into 3D models suitable for AR experiences. For instance, a pie chart could become an interactive 3D object that users can manipulate in an AR environment. Dynamic AR Scenes can be generated. Process 400 can use generative AI to create entire AR scenes that represent data trends or relationships, allowing for immersive data exploration.

In step 408, process 400 can perform Anomaly Detection and Highlight Generation. Process 400 can implement Intelligent Outlier Identification. Generative AI models can be trained to identify and creatively highlight anomalies or interesting patterns in the data, drawing attention to key insights. This can include Visual Emphasis Generation. Process 400 can use AI to generate visual elements (e.g., arrows, spotlights, or animated effects) that guide the viewer's attention to important aspects of the data presentation.

In step 410, process 400 can create Personalized Presentations. This can include, inter alia, Audience Adaptation operations. Generative AI can tailor the presentation style, complexity, and focus based on the intended audience, generating different versions of the same data for technical experts, executives, or the general public. This can include Dynamic Content Generation. As new data comes in, the system can use generative AI to automatically update and regenerate relevant parts of the presentation, ensuring it stays current.

In step 412, process 400 can perform Multi-modal Integration. This can include, by way of example, Voice Narration. Generative AI can produce natural-sounding voice narrations to accompany visual presentations, enhancing accessibility and engagement. Process 400 can also create and integrate Music and Sound Effects. Generative AI can generate or select appropriate background music and sound effects that complement the mood and message of the data presentation.

In step 414, process 400 can perform Hypothesis Generation. This can include determining various Predictive Scenarios. Based on historical data and trends, generative AI can create hypothetical future scenarios and visualize them, aiding in forecasting and strategic planning.

In step 416, process 400 can perform Expert Knowledge Simulation. Process 400 can provide an AI-powered Expert System. Generative AI can simulate domain expertise, providing insights and interpretations that mimic those of human experts in the field relevant to the data.

By integrating these generative AI capabilities, the system can transform raw quantitative data into rich, interactive, and insightful presentations that go beyond traditional charts and graphs. This approach makes data more accessible, engaging, and actionable for a wide range of audiences.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by this United States patent:

1. A computerized method for used for automatic richer presentation of quantitative data with generative artificial intelligence (AI), comprising:
obtaining a set of quantitative data to provide a richer presentation;
determining a set of statistical attributes of the set of quantitative data; and
inputting portions of the quantitative data set as one or more prompts into at least one text-to-image Generative AI model to generate one or more richer presentations of the quantitative data.

2. The computerized method of claim 1, wherein the set of quantitative data comprises demographic cohort data, education institution data, and health institution data.

3. The computerized method of claim 1, wherein the set of quantitative data comprises government data sets, sports data, actuarial data, real-estate data sets, economic data sets, biological data sets, geographical data sets.

4. The computerized method of claim 1, wherein the statistical attributes are calculated and visualized via a text-to-image model.

5. The computerized method of claim 4, wherein the statistical attributes comprise a percentage attribute of the data values in each category.

6. The computerized method of claim 4, wherein the statistical attributes comprise a variance attribute of the data values in each category.

7. The computerized method of claim 4, wherein the statistical attributes comprise a standard deviation attribute of the data values in each category.

8. The computerized method of claim 4, wherein the statistical attributes comprise an outlier attribute for quantitative data of the data values in each category.

9. The computerized method of claim 1, wherein the digital images can be converted to augmented reality images.

10. The computerized method of claim 1, wherein the digital images and the quantitative data sets are used as prompts to generative AI art generation.
